(19) United States
(12) Patent Application Publication
(10) Pub. No.: US 2002/0195844 A1
(43) Pub. Date: Dec. 26, 2002

(54) Headliner plastic welding

(75) Inventor: Jesse G. Hipwell, Columbiaville, MI (US)

Correspondence Address: Mark D. Chuey, 1000 Town Center, 22nd Floor, Southfield, MI, 48075-1351, US

(73) Assignee: Lear Corporation, Southfield, MI

(21) Appl. No.: 10/175,620

(22) Filed: Jun. 20, 2002

Related U.S. Application Data
(60) Provisional application No. 60/300,996, filed on Jun. 26, 2001.

(51) Int. Cl. B60R 13/02

(52) U.S. Cl. 296/214

(57) ABSTRACT

Plastic welding may be used to attach various components for a vehicle headliner assembly. In an embodiment, the headliner assembly includes a polymer substrate material accepting a cover stock material on the substrate bottom side. The substrate material is fixtured. Polymer headliner component parts are fixtured relative to the substrate material and plastic welded to the substrate material.

### CROSS-REFERENCE TO RELATED APPLICATIONS

This application claims the benefit of U.S. provisional application Serial No. 60/300,996 filed Jun. 26, 2001, which is herein incorporated by reference in its entirety.

### BACKGROUND OF THE INVENTION

1. Field of the Invention

The present invention relates to vehicle headliners and their construction.

2. Background Art

A vehicle headliner lines the inside surface of a vehicle roof. Vehicle headliners perform a variety of functions. First, headliners provide a cushion between the vehicle body interior and the vehicle roof. Second, headliners provide a convenient means of routing and attaching components in the vehicle interior. Such components may be attached to face the interior of the body compartment or may be attached between the headliner and the inside surface of the vehicle roof. Third, headliners provide an aesthetic ceiling for the vehicle interior.

Headliners may be constructed in a variety of ways. Typically, a rigid material such as fiberglass, PET, urethane thermoset, and the like provides the backing for a cover stock material such as cloth, leather, and the like. When installed in a vehicle, the cover stock faces the vehicle interior. The side of the cover stock facing the vehicle interior is known as the A-surface. The interface between the cover stock and the substrate is known as the B-surface. The side of the substrate facing the vehicle roof is known as the C-surface. A liquid adhesive or an adhesive film may be used at the B-surface to attach the cover stock to the substrate.

A variety of components are attached to headliners. These include garnish pieces, retainers and backplates, sheet metal attachment mechanisms for attaching the headliner to the vehicle roof, wiring, hoses and tubes, head impact counter measures, and the like. Typically, these components are attached to the headliner using an adhesive such as thermoplastic hot melt. However, this method has several problems. First, the adhesive is often applied by hand such as, for example, through the use of a hot melt gun. This technique is labor intensive and difficult for workers who must operate close to the glue which is heated to approximately 350° F. Second, the application of adhesives such as hot melt glue is a messy process. Often, strings of glue migrate to the A-surface of the headliner causing an unacceptable appearance flaw. Third, the application of adhesives such as hot melt add additional weight to the assembly. Elimination of glue would reduce part weight and, thus, positively affect gas milage. Fourth, the adhesives represent an additional part on the vehicle bill of materials. Eliminating the adhesives represents a piece part savings. Fifth, the use of a thermoplastic adhesive decreases the pull-off force of components at elevated temperatures. Sixth, the use of adhesives, particularly hot melt glue, complicates location control of component pieces on the headliner.

What is needed is an ability to attach component parts to the headliner that eliminates or greatly reduces the need for adhesives such as hot melt glue. Such a headliner assembly should be more easily manufactured, weigh less, and have a reduced parts count as compared to traditional headliner assemblies.

### SUMMARY OF THE INVENTION

The present invention provides a vehicle headliner assembly and a method of making such an assembly using plastic welding to attach various components to the substrate material.

A method of making a vehicle headliner assembly is provided. The headliner assembly includes a polymer substrate material accepting a cover stock material on the substrate bottom side. The substrate material is fixtured. A plurality of polymer headliner component parts are fixtured relative to the substrate material. The headliner components are plastic welded to the substrate material.

In a variety of embodiments, different plastic welding techniques may be used including vibration welding, hot plate welding, sonic welding, radio frequency welding, and the like. Heat staking may also be used.

Various types of headliner components may be used. Headliner components may include at least one garnish piece. Headliner components may also include at least one retainer or backplate for supporting additional components such as visors, visor center supports, grab handles, lamps, wiring harnesses, air ducts, rear washer hoses, drain tubes, and the like. Headliner components may also include at least one sheet metal attachment. Further, components such as wiring harnesses, rear washer hoses, drain tubes, ducts, and head impact countermeasures may be directly welded to the headliner.

A vehicle headliner assembly is also provided. The headliner assembly includes a polymer support substrate having a bottom surface facing into the vehicle body interior and a top surface opposing the bottom surface. A cover stock is adhered to the support substrate bottom surface either before, after or as part of forming the substrate. Polymer headliner components are plastic welded to the support substrate top surface.

A method of making a vehicle headliner assembly including a wiring harness is also provided. A polymer substrate is formed. A cover stock is attached to the substrate bottom surface. A wiring harness assembly is plastic welded directly to the substrate top surface.

A method of making a vehicle headliner assembly including at least one air duct is also provided. A polymer substrate is formed. A cover stock is attached to the substrate bottom surface. At least one air duct is plastic welded directly to the substrate top surface.

A method of making a vehicle headliner assembly including at least one fluid tube is also provided. A polymer substrate is formed. A cover stock is attached to the substrate bottom surface. At least one fluid tube is plastic welded directly to the substrate top surface.

A method of making a vehicle headliner assembly including head impact countermeasures is also provided. A polymer substrate is formed. A cover stock is attached to the substrate bottom surface. At least one head impact countermeasure is plastic welded directly to the substrate top surface.

A method of making a vehicle headliner assembly including at least one sheet metal attachment is also provided. A polymer substrate is formed. A cover stock is attached to the substrate bottom surface. At least one sheet metal attachment is plastic welded to the substrate top surface.

A method of making a vehicle headliner including at least one trim retainer is provided. A polymer substrate is formed. A cover stock is attached to the substrate bottom surface. At least one trim retainer is plastic welded to the substrate top surface.

A method of making a vehicle headliner using staking is also provided. A substrate is formed. A cover stock is attached to the bottom surface of the substrate. A plurality of headliner components are formed. Each headliner component has at least one stake extending from a component contact surface designed to contact the cover stock. Each headliner component is inserted through a hole formed in the substrate such that the component contact surface contacts the cover stock with each stake extending through the substrate. Each headliner component is staked to the substrate by applying heat and pressure to each stake extending through the substrate.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is an exploded view drawing illustrating a vehicle headliner assembly having backplates and retainers according to an embodiment of the present invention;

FIG. 2 is an exploded view drawing illustrating a vehicle headliner assembly having sheet metal attachments and sound reducers according to an embodiment of the present invention;

FIG. 3 is an exploded view drawing illustrating a vehicle headliner assembly having a wire harness according to an embodiment of the present invention;

FIG. 4 is an exploded view drawing illustrating a vehicle headliner assembly having a washer hose or drain tube according to an embodiment of the present invention;

FIG. 5 is an exploded view drawing illustrating a vehicle headliner assembly having an air duct according to an embodiment of the present invention;

FIG. 6 is an exploded view drawing illustrating a vehicle headliner assembly having head impact countermeasures according to an embodiment of the present invention;

FIG. 7 is a drawing illustrating attached head impact countermeasures according to an embodiment of the present invention;

FIG. 8 is a cross-sectional drawing illustrating vibration welding according to an embodiment of the present invention;

FIG. 9 is a cross-sectional drawing illustrating hot plate welding according to an embodiment of the present invention;

FIG. 10 is a cross-sectional diagram illustrating sonic welding according to an embodiment of the present invention;

FIG. 11 is a cross-sectional drawing illustrating radio frequency welding according to an embodiment of the present invention;

FIG. 12 is a drawing illustrating a console and headliner according to an embodiment of the present invention;

FIG. 13 is a drawing illustrating a console with heat stakes and a headliner prepared for heat staking according to an embodiment of the present invention;

FIG. 14 is a cross-sectional drawing of the heat-stakable console;

FIG. 15 is a drawing illustrating a headliner assembly with a heat staked console according to an embodiment of the present invention; and

FIG. 16 is a cross-sectional drawing illustrating a console heat staked to a headliner according to an embodiment of the present invention.

### DETAILED DESCRIPTION OF THE PREFERRED EMBODIMENT(S)

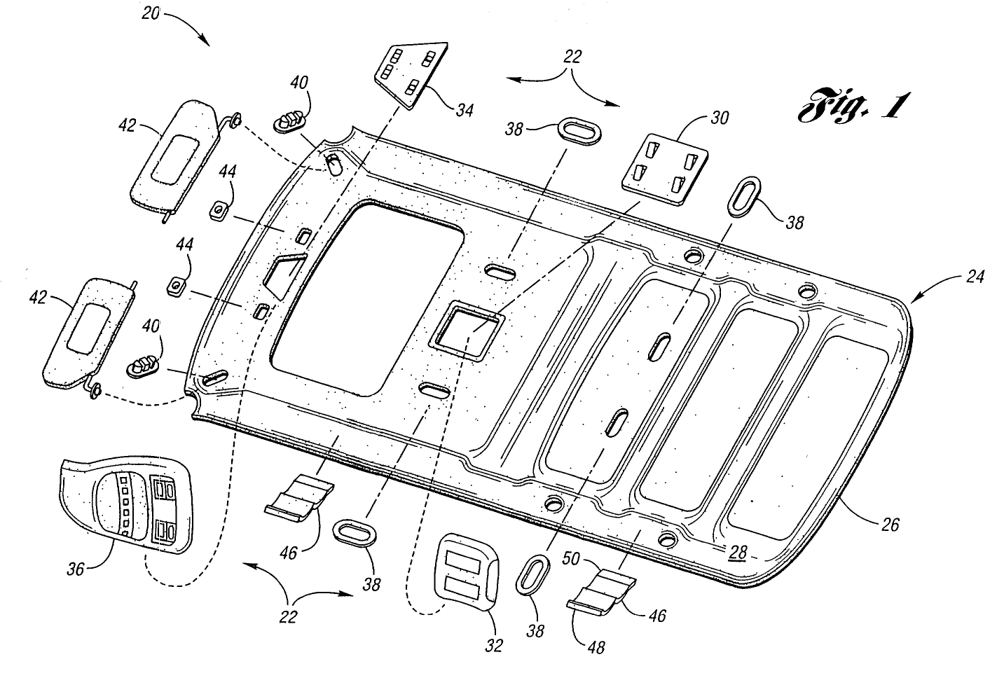

Referring to FIG. 1, an exploded view drawing illustrating a vehicle headliner assembly having backplates and retainers according to an embodiment of the present invention is shown. A headliner assembly, shown generally by 20, includes a variety of components, shown generally by 22, attached to a headliner, shown generally by 24. Headliner 24 is itself an assembly typically including substrate 26 and a cover stock material, not shown in FIG. 1. Typically, the surface of the cover stock material not facing substrate 26 is referred to as the A-surface. The interface between the cover stock material and substrate 26 is referred to as the B-surface. The surface of substrate 26 facing away from the cover stock material is known as C-surface 28. The view in FIG. 1 is shown looking down on C-surface 28.

Substrate 26 is comprised of a thermoplastic polymer such as polypropylene. Substrate 26 may be constructed to include a glass fiber scrim for reinforcement. Substrate 26 may also be constructed as a laminate provided C-surface 28 is a thermoplastic material. Cover stock material is typically cloth which is fixed to substrate 26 using an adhesive or adhesive film. Cover stock material may be attached to substrate 26 before or after substrate 26 is formed. Further, the cover stock may be attached to substrate 26 as part of the process of forming substrate 26. Preferably, headliner 24 is formed prior to plastic welding operations. However, plastic welding operations may be performed prior to attaching cover stock to substrate 26.

Components 22 are attached to headliner 24 using one of a variety of plastic welding techniques. Plastic welding offers a variety of advantages over the use of adhesives. First, location of components 22 on headliner 24 may be improved. Second, retention of components 22 at elevated temperatures is improved. Third, in addition to reducing or eliminating the need for adhesive to attach components 22 to headliner 24, retainers and other support components may be eliminated from headliner assembly 20. Fourth, the process for manufacturing headliner assembly 20 is simplified and assembly time reduced.

A wide variety of components 22 may be plastic welded to headliner 24. Dome lamp retainer 30 may be plastically welded directly to C-surface 28. Dome lamp 32 is held by dome lamp retainer 30 against the A-surface of headliner 24. Dome lamp 32 may be attached to dome lamp retainer 30 using screws, clips, or the like. Similarly, console retainer 34 may be plastic welded directly to C-surface 28 for holding console 36 against the A-surface of headliner 24. AC vent retainers 38 for holding air conditioning vents may also be plastically welded directly to C-surface 28: Visor retainer 40 for holding visor 42 and visor center support retainer 44 may also be plastically welded to C-surface 28. Retainers and backplates for various other garnish components such as grab handles, coat hooks, illuminated bezzles and the like may also be plastically welded to headliner 24.

Retainer clips 46 may be plastically welded to C-surface 28 for routing and retaining wiring harnesses, drain tubes, washer hoses, and the like. Retainer clip 46 may include hinged portion 48 which wraps around and is held by clip portion 50 to retain a component between headliner 24 and the vehicle roof.

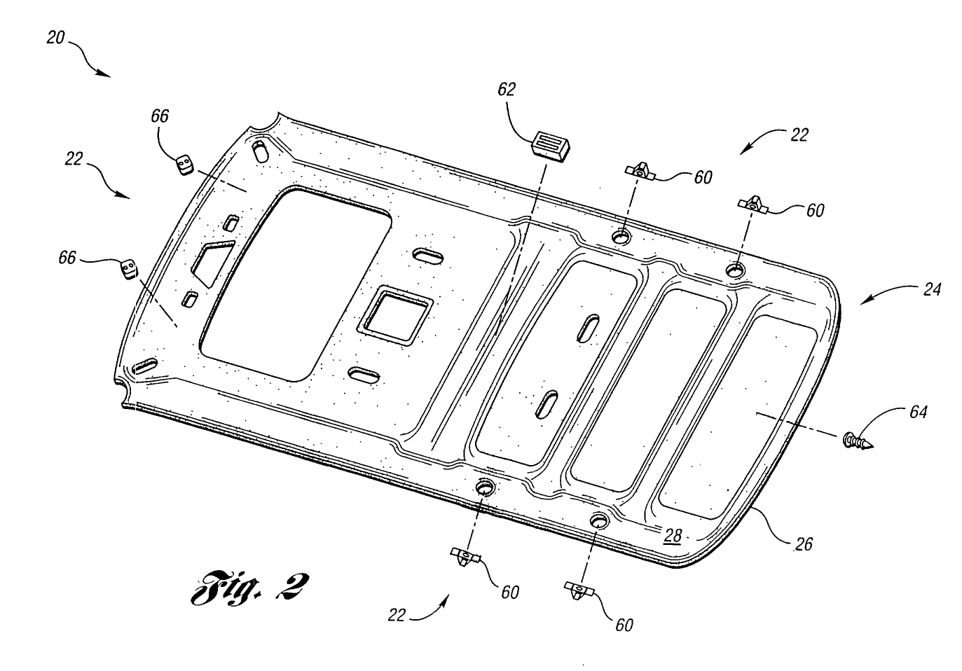

Referring now to FIG. 2, an exploded view drawing illustrating a vehicle headliner assembly having sheet metal attachments and sound reducers according to an embodiment of the present invention is shown. Various components 22 can be plastically welded to C-surface 28 for attaching headliner 24 to the vehicle roof. These include Z-access clips 60, magnet assembly 62, push pins 64, velcro assemblies, and the like. Various vibration and sound deadening components 22 may also be attached to C-surface 28. These include foam stuffers 66, velcro assemblies for attaching deadening components, and the like.

Referring now to FIG. 3, an exploded view drawing illustrating a vehicle headliner assembly having a wire harness according to an embodiment of the present invention is shown. A wiring harness, shown generally by 70, includes a plurality of wires 72 typically terminated by connectors 74. Wires 72 are enclosed in sheath 76 for at least a portion of their length. Sheath 76 may be constructed of a thermoset polymer permitting sheath 76 to be plastically welded to C-surface 28. Sheath 76 may be welded to headliner 24 either prior to or after wires 72 are inserted in sheath 76.

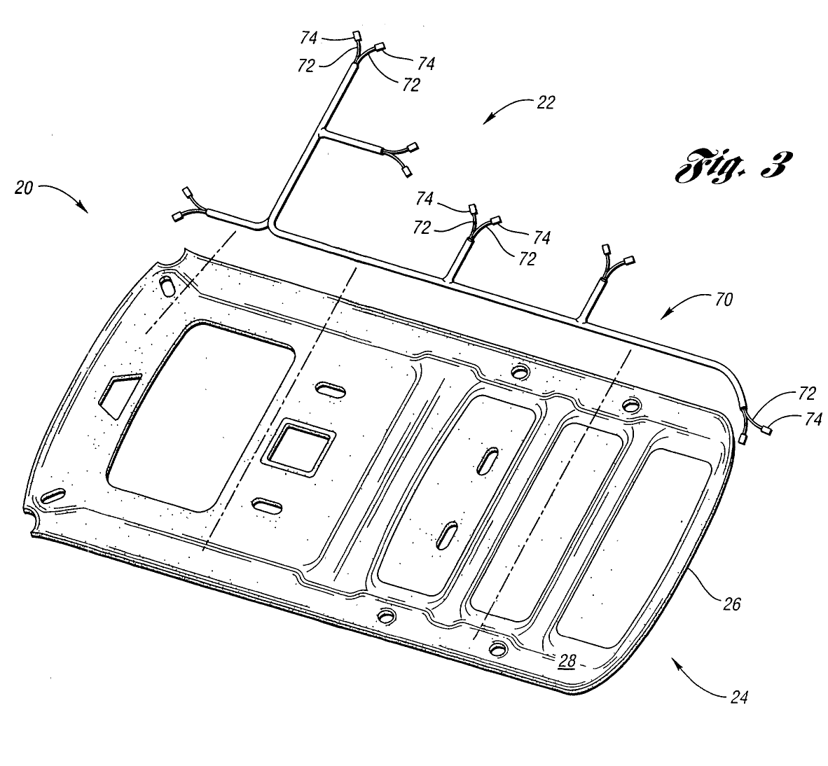

Referring now to FIG. 4, an exploded view drawing illustrating a vehicle headliner assembly having a washer hose or drain tube according to an embodiment of the present invention is shown. Hose 80, which may be, for example, a rear washer hose, drain tube, or the like, is made with a thermoplastic material permitting hose 80 to be plastically welded directly to C-surface 28.

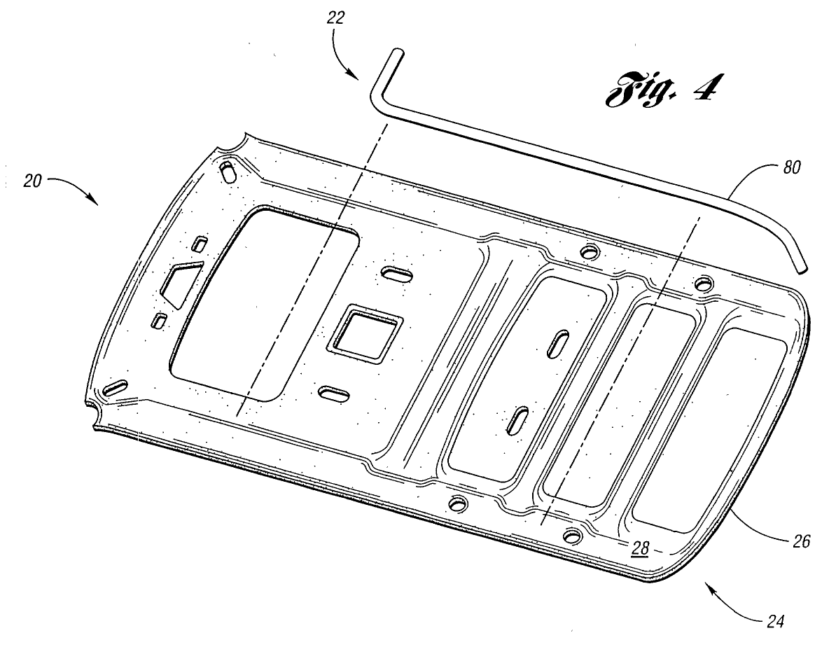

Referring now to FIG. 5, an exploded view drawing illustrating a vehicle head assembly having an air duct according to an embodiment of the present invention is shown. Air duct 86 may be formed from a thermoplastic material using a variety of processes such as blow molding, vacuum forming, compression forming, and the like. This permits ducts 86 to be plastically welded directly to C-surface 28. Air duct 86 may be formed as a single piece, in a clam shell arrangement, or as separate portions which snap together to form a duct. In the latter case, a portion of air duct 86 is plastic welded to headliner 24 with the remaining portion of air duct 86 snapped into the welded portion.

Referring now to FIG. 6, an exploded view drawing illustrating a vehicle headliner assembly having head impact countermeasures according to an embodiment of the present invention is shown. Head impact countermeasures (HIC) 90 absorb shock when something within the vehicle passenger compartment strikes headliner 24. HIC 90 may be made from a variety of material including polystyrene, EPP bead, GECET bead, urethane, OFLEX, SAFTY plastic, Dow strand, Hexel, and the like. HIC 90 may be plastic welded directly to C-surface 28.

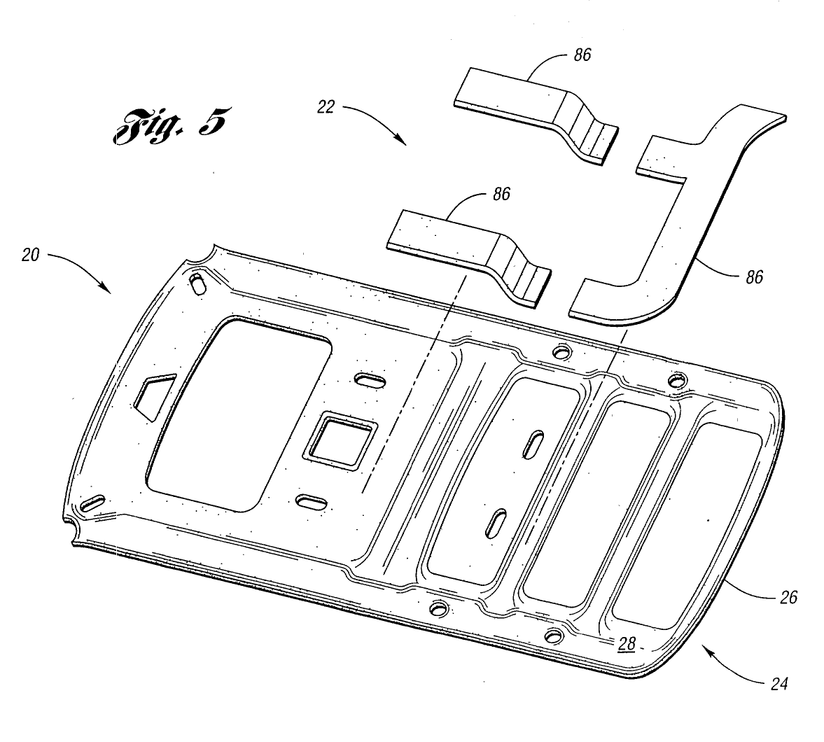

Referring now to FIG. 7, a drawing illustrating attached head impact countermeasures according to an embodiment of the present invention is shown. HIC 90 is shown welded to C-surface 28 of substrate 26. With regards to FIGS. 8-11, cross-sectional views of vehicle headliner assembly 20 will be used to illustrate various plastic welding techniques which may be used to attach components 22, such as HIC 90, to headliner 24.

Referring now to FIG. 8, a cross-sectional drawing illustrating vibration welding according to an embodiment of the present invention is shown. Headliner 24 is shown in cross-section with cover stock 100 joined to substrate 26 at B-surface 102. A-surface 104 faces away from substrate 26. Headliner 24 is fixtured in headliner nest 106, not shown for clarity. Component 22 such as, for example, HIC 90 is fixtured in component nest 108, not shown for clarity. Details of fixtures 106, 108 have not been included in FIG. 8. The design of fixtures for holding parts such as headliner 24 and component 22 is well known in the art.

Component 22 is vibrated under pressure against headliner 24. Exact values for vibration frequency, duration, pressure, and the like vary with the configuration and material used for component 22 and substrate 26. For example, HIC 90 is vibrated relative to substrate 26 made of glass filled polyethylene in a direction normal to the cross-sectional plane at 240 Hz under 30 psi for three seconds followed with a hold time of two seconds under 30 psi.

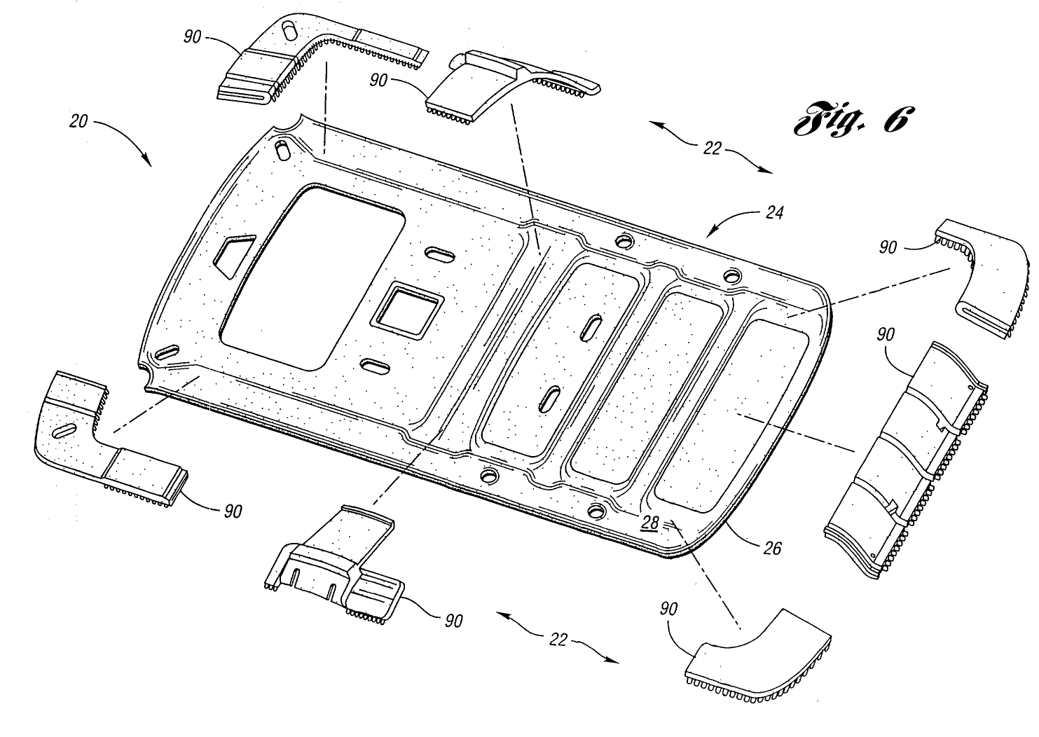

Referring now to FIG. 9, a cross-sectional drawing illustrating hot plate welding according to an embodiment of the present invention is shown. Headliner 24 is fixtured in headliner nest 106. Component 22 is fixtured in component nest 108. Hot plate 120 is applied to either or both of component 22 and C-surface 28 and then removed. Component 22 and headliner 24 are then joined and held in place until the heated plastic member cools. Once again, parameters such as temperature, time, pressure, and the like vary depending on the makeup of component 22 and substrate 26. For example, hot plate 120 at 550° F. is held against HIC 90 for eight seconds. HIC 90 is then pressed against C-surface 28 at 30 psi for eight seconds.

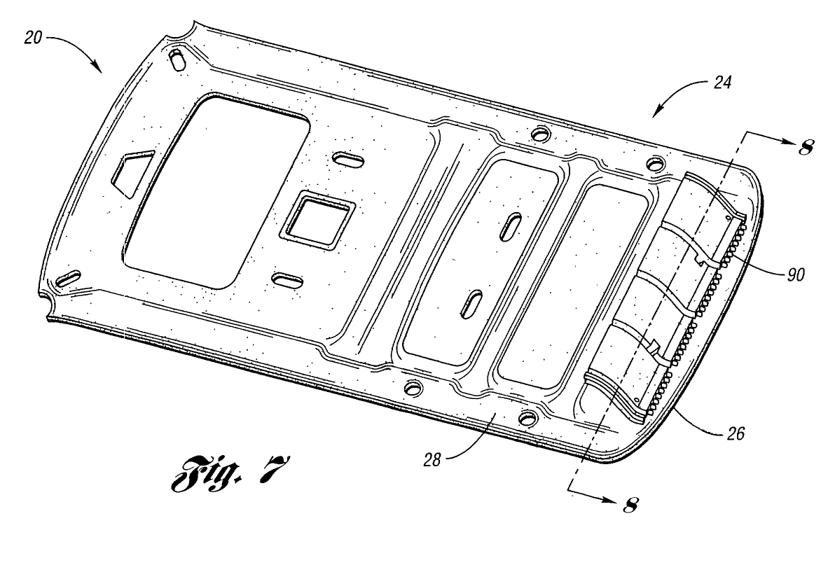

Referring now to FIG. 10, a cross-sectional diagram illustrating sonic welding according to an embodiment of the present invention is shown. Headliner 24 is fixtured in headliner nest 106. Component 22 is fixtured in component nest 108 which includes horn 130 and sonic weld tip 132. Sound travels down horn 130 and radiates from sonic weld tip 132 onto component 22. This sound causes component 22 to vibrate relative to headliner 24. Heat generated through this vibration welds component 22 to C-surface 28.

Referring now to FIG. 11, a cross-sectional drawing illustrating radio frequency welding according to an embodiment of the present invention is shown. Headliner 24 is fixtured in headliner nest 106 and component 22 is fixtured in component nest 108. Weld agent 140 is applied to either or both of C-surface 28 and component 22. For example, component 22 may be dipped into weld agent 140, such as liquid polyether. Weld agent 140 may also be a viscous liquid which can be silk screened or roll coated onto C-surface 28. Weld agent 140 may also be a film applied to C-surface 28. RF source 142 generates a radio frequency signal which is transmitted by antenna 144 towards headliner 24. This radio frequency energy excites weld agent 140, which releases sufficient heat to plastically weld component 22 to substrate 26.

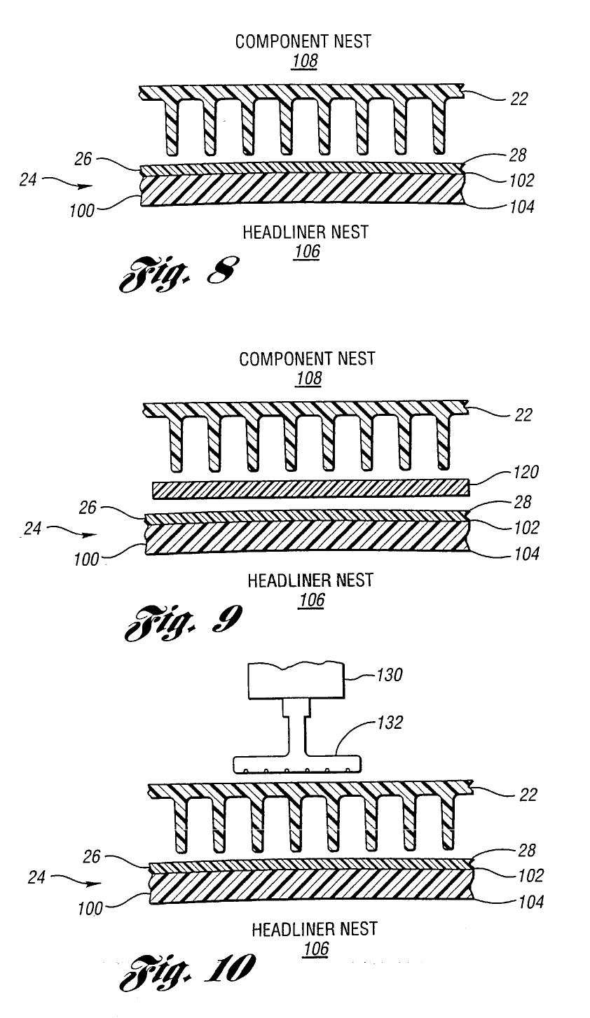

Referring now to FIG. 12, a drawing illustrating a console to be staked to a headliner is shown. Console 150 is to be attached to headliner 24 such that console 150 extends from A-surface 104.

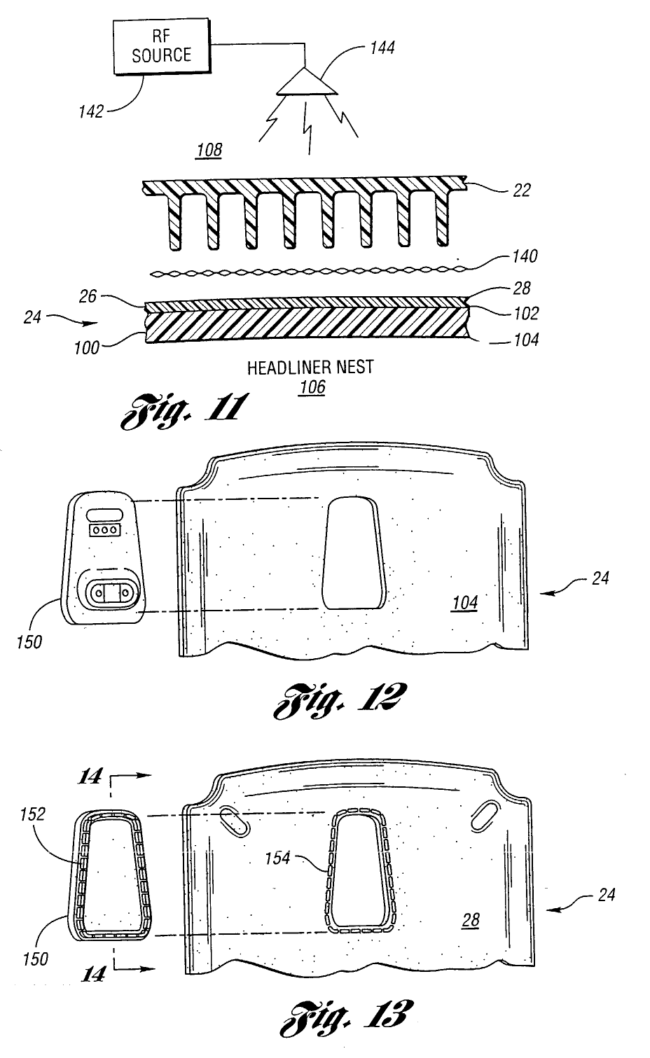

With reference to FIG. 13, a drawing illustrating a console with heat stakes and a headliner prepared for heat staking, and to FIG. 14, a cross-sectional drawing of a heat stakable console, heat staking according to an embodiment of the present invention is shown. Console 150 has a plurality of stakes 152 extending from the portion of console 150 designed to contact A-surface 104. Headliner 24 contains slots or holes 154 corresponding to stakes 152 on console 150. Holes 154 may pass entirely through headliner 24 or may only pass through substrate 26 with stakes 152 punching through cover stock 100. Alternatively, stakes 152 may punch through both cover stock 100 and substrate 26.

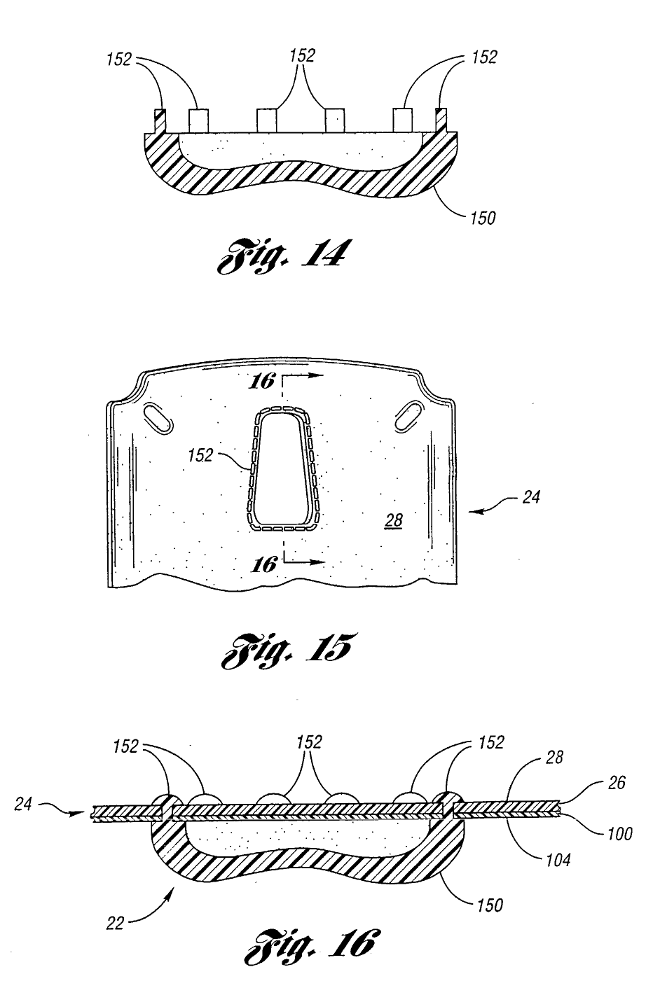

Referring now to FIG. 15, a drawing illustrating a headliner assembly with a heat staked console according to an embodiment of the present invention as shown. Heated anvils are pressed against stakes 152 to melt stakes 152 over C-surface 28. This holds console 150 in place without the need of a retainer or bracket.

Referring now to FIG. 16, a cross-sectional diagram illustrating a console heat staked to a headliner according to an embodiment of the present invention is shown. Stakes 152 are shown flattened onto C-surface 28 of headliner 24. This holds console 150 firmly in place against A-surface 104.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a vehicle headliner assembly, the headliner assembly including a polymer substrate material accepting a cover stock material on a substrate bottom side, the method comprising:
fixturing the substrate material;
fixturing a plurality of polymer headliner component parts relative to the substrate material; and
plastic welding the plurality of headliner components to the substrate material.

2. A method of making a vehicle headliner assembly as in claim 1 wherein plastic welding comprises vibration welding.

3. A method of making a vehicle headliner assembly as in claim 1 wherein plastic welding comprises hot plate welding.

4. A method of making a vehicle headliner assembly as in claim 1 wherein plastic welding comprises sonic welding.

5. A method of making a vehicle headliner assembly as in claim 1 wherein plastic welding comprises radio frequency welding.

6. A method of making a vehicle headliner assembly as in claim 1 wherein plastic welding comprises staking.

7. A method of making a vehicle headliner assembly as in claim 1 wherein the plurality of headliner components comprises at least one garnish piece.

8. A method of making a vehicle headliner assembly as in claim 1 wherein the plurality of headliner components comprises at least one retainer, each retainer supporting at least one of a set including visor, visor center support, grab handle, lamp, wiring harnesses, air duct, rear washer hose and drain tube.

9. A method of making a vehicle headliner assembly as in claim 1 wherein the plurality of headliner components comprises at least one sheet metal attachment.

10. A method of making a vehicle headliner assembly as in claim 1 wherein the plurality of headliner components comprises at least one from a set including wiring harness, rear washer hose, drain tube, duct and head impact countermeasures.

11. A vehicle headliner assembly comprising:
a polymer support substrate having a bottom surface facing into a vehicle body interior and a top surface opposing the bottom surface;
a cover stock adhered to the support substrate bottom surface; and
a plurality of polymer headliner components plastic welded to the support substrate top surface.

12. A method of making a vehicle headliner assembly comprising:
forming a polymer substrate;
attaching a cover stock to a substrate bottom surface; and
plastic welding a wiring harness assembly directly to a substrate top surface.

13. A method of making a vehicle headliner assembly comprising:
forming a polymer substrate;
attaching a cover stock to a substrate bottom surface; and
plastic welding at least one air duct directly to a substrate top surface.

14. A method of making a vehicle headliner assembly comprising:
forming a polymer substrate;
attaching a cover stock to a substrate bottom surface; and
plastic welding at least one fluid tube directly to a substrate top surface.

15. A method of making a vehicle headliner assembly comprising:
forming a polymer substrate;
attaching a cover stock to a substrate bottom surface; and
plastic welding at least one head impact countermeasure directly to a substrate top surface.

16. A method of making a vehicle headliner assembly comprising:
forming a polymer substrate;
attaching a cover stock to a substrate bottom surface; and
plastic welding at least one sheet metal attachment to a substrate top surface.

17. A method of making a vehicle headliner assembly comprising:
forming a polymer substrate;
attaching a cover stock to a substrate bottom surface; and
plastic welding at least one trim retainer to a substrate top surface.

18. A method of making a vehicle headliner assembly comprising:
forming a substrate;
attaching a cover stock to a bottom surface of the substrate;
forming a plurality of headliner components, each headliner component including at least one stake extending from a component contact surface designed to contact the cover stock;
inserting each headliner component stake through a hole formed in the substrate such that the component contact surface contacts the cover stock, each stake extending through the substrate; and
staking each headliner component to the substrate by applying heat and pressure to each stake extending through the substrate.

19. A method of making a vehicle headliner assembly, the headliner assembly including a thermoplastic layer, the method comprising plastic welding a plurality of headliner components by plastically deforming the thermoplastic layer.

20. A method of making a vehicle headliner assembly, the headliner assembly including a headliner and at least one plastically weldable headliner components, the method comprising plastic welding each plastically weldable headliner component to the headliner.
